(19) United States
(12) Patent Application Publication
(10) Pub. No.: US 2023/0107062 A1
(43) Pub. Date: Apr. 6, 2023

(54) EXHAUSTING OF HOT GASES FROM WITHIN AN AIRCRAFT

(71) Applicant: Airbus (S.A.S.), Blagnac (FR)

(72) Inventors: Oliver Family, Bristol (GB); José Angel Hernanz-Manrique, Bristol (GB); Juan Olivares-Berlanga, Bristol (GB)

(21) Appl. No.: 17/954,817

(22) Filed: Sep. 28, 2022

(30) Foreign Application Priority Data
Sep. 29, 2021 (GB) 2113961.3

(51) Int. Cl. B64D 33/04; B64C 21/02

(52) U.S. Cl. CPC B64D 33/04; B64C 21/02; B64D 2027/026

(57) ABSTRACT

An aircraft may have one or more electrically powered thrust-generating engines and a combustion engine forming part of a power generator system for powering the electric engine and/or recharging a battery system that powers the electric engine. An exhaust pipe leads via an interior space within the aircraft from the exhaust of the combustion engine, or other source of hot gases, to an exhaust outlet. The direction of the exhaust pipe at the outlet is transverse to the longitudinal axis of the aircraft. A fairing immediately upstream of the outlet has a trailing edge, for example with a sawtooth profile, which creates turbulence and/or chaotic airflow over and downstream of the outlet, and thus mixes the freestream air and the hot gases from inside the aircraft more efficiently.

### TECHNICAL FIELD

The disclosure herein concerns an apparatus and method for exhausting of hot gases from within an aircraft. Particularly, but not exclusively, this disclosure herein concerns an aircraft or aircraft structure comprising an exhaust outlet on an outer surface of the aircraft structure, through which outlet hot gases from inside the aircraft are exhausted into the surrounding atmosphere. The disclosure herein also concerns a method of exhausting hot gas from within an aircraft via an outlet.

### BACKGROUND

An aspect of the disclosure herein concerns a structure for an aircraft that facilitates the efficient exhausting of hot gases from within the aircraft into the free-stream flow around the aircraft when airborne. One potential application of the disclosure herein relates to an aircraft that is powered at least in part by one or more electric motors. With an increasing need to develop aircraft technology that reduces emissions that adversely impact the climate or environment, there has been work on developing electrically powered aircrafts. One such project has been the E-Fan X demonstrator which was developed by Airbus. An aim of the project was to design and test an aircraft that is at least partly powered by an electric motor. A demonstrator aircraft has been tested in which one of four conventional jet engines is replaced by an electric motor.

A possible configuration of an electric aircraft is a hybrid model, in which a combustion engine accommodated within the aircraft is used to recharge one or more electric energy cells (e.g. batteries), which may also be accommodated within the aircraft. The size, configuration, location and/or other design parameters of such a combustion engine may be such that conventional means of exhausting the hot exhaust gases from within a region in the aircraft are inadequate and/or could be improved. There may also be other applications for an improved way in which to remove exhaust gases, or other hot gases, from an aircraft.

### SUMMARY

The disclosure herein provides, according to a first aspect, an exhaust outlet and an associated fairing for use with an aircraft structure. The aircraft structure comprises an outer surface that in use is on the exterior of an aircraft. The aircraft has a longitudinal axis. The outer surface of the aircraft structure accommodates the exhaust outlet. The exhaust outlet is configured to allow hot gases to flow from within the aircraft to the exterior of the aircraft. The direction of flow of gases immediately before exiting via the exhaust outlet may predominantly be transverse to the longitudinal axis of the aircraft. The outer surface of the aircraft structure extends downstream of the exhaust outlet, for example by a distance greater than the length of the outlet in the longitudinal direction (i.e. a direction parallel to the longitudinal axis of the aircraft, and along and substantially parallel to the streamwise direction) and/or, for example, a distance greater than 1 meter. It will be understood that the word “downstream” in this context is used with reference to direction of the flow of air relative to the aircraft during flight and is therefore the fore-to-aft direction. At least a part of, and preferably the majority of (in some embodiments all of) the fairing is located upstream of the outlet. The fairing may be provided immediately upstream of (e.g. directly adjacent to) the exhaust outlet. In embodiments, the fairing advantageously has a shape (e.g. at and/or formed by the trailing edge of the fairing) that that creates turbulence and/or chaotic airflow over and downstream of the outlet. In such embodiments, it may be that the creation of such turbulence and/or chaotic airflow assists in the mixing of hot gases from the exhaust outlet with the freestream air, thus reducing the risk of over-heating of the aircraft structure downstream of the exhaust outlet. It may therefore also be the case that, in such embodiments, the hot gases may be better and more efficiently dispersed within the freestream air. In certain embodiments it may be that the fairing creates turbulent airflow downstream of the outlet so as to mix the freestream air and the hot gas more rapidly than would be the case without the fairing. In embodiments of the disclosure herein, such measures are beneficial despite the direction of flow of gases from the exhaust outlet essentially being perpendicular to direction of the freestream air relative to the aircraft. When the aircraft is not airborne and is either stationary or moving at slow speed on the ground, hot gases may be exhausted in a direction transverse to the longitudinal axis of the aircraft and therefore directly away from the aircraft. In such a case, while the fairing may have little effect on the way in which the hot gases are exhausted, the direction of the exhaust gases is not significantly affected by any freestream or ambient airflows around the aircraft.

The hot gases from the exhaust outlet flow from a region within the body of the aircraft. The hot gases may be exhaust gases, for example from a combustion engine. In some embodiments, the hot gases may be hot air from a heat exchanger operating in the body of the aircraft.

The exhaust outlet will typically be surrounded by the outer surface of the aircraft structure and may be substantially flush with the outer surface. The outer surface immediately surrounding the outlet may be in the form of the outer skin of the aircraft, for example. There may be an exhaust duct (e.g. a pipe) that terminates at the exhaust outlet. The exhaust duct extends from inside the aircraft, for example from a supply of hot gases. As mentioned above, the direction of flow of gases immediately before exiting via the exhaust outlet may be predominantly transverse to the longitudinal axis of the aircraft. In some embodiments, the direction of flow of gases before exiting the outlet may be perpendicular or close to perpendicular to the longitudinal axis of the aircraft (for example, within +/−30 degrees to perpendicular). If the direction of flow of gases is difficult to determine accurately, it may be assumed that the direction of flow of gases immediately before the outlet is parallel to the direction of the axis of a duct or pipe that carries the gases to the outlet at a location immediately upstream (in the direction of flow of hot gases) of the outlet. For example, in embodiments, the direction of the exhaust duct will typically be transverse to the longitudinal axis in the region directly adjacent to the exhaust outlet. It may be that the direction of flow of gases immediately before exiting via the exhaust outlet is transverse (e.g. perpendicular +/−30 degrees) to the surface of the outer skin of the aircraft structure surrounding the outlet and/or transverse to the plane of the exhaust outlet. The direction of the exhaust duct in the region directly adjacent to the exhaust outlet may be different from the direction of the exhaust duct in a region upstream of the outlet (it being understood that “upstream” in this context is with reference to direction of the flow of hot gases). The exhaust duct may comprise a bend, for example an elbow section, between the source of hot gases and the outlet.

The outlet may comprise a grid. The grid may have a depth in the direction of flow of hot gases and may be arranged to assist in directing/entraining the flow of gases from the outlet. If such a grid or other similar device is present the direction of flow of gases immediately before the outlet may be assumed to be parallel to the direction of flow defined by the grid or similar device. The outlet may be positioned exclusively on the starboard side or exclusively on the port side of the aircraft (i.e. to one side or the other of the longitudinal axis when viewed in plan). The area of the outlet may be at least 0.05 m², preferably 0.1 m² or more. The area of the outlet may be less than 1.0 m². The outlet may have a width that is 10 cm or more, preferably at least 20 cm. The width of the fairing, at its widest, is preferably greater than the width of the outlet. The width of the fairing, at its widest, may be 10 cm or more, preferably at least 20 cm. The length of the fairing may be 10 cm or more, preferably at least 25 cm.

In use, as air flows over the fairing the airflow will detach from the faring at one or more locations on the fairing, for example at its trailing edge. The fairing may have a shape which creates a series of airflow detachment regions distributed across the width of the fairing (in embodiments, the direction of the width of the fairing may be perpendicular to the longitudinal axis of the aircraft, but not necessarily horizontal). The shape and/or configuration of such airflow detachment regions may assist in disturbing the local airflow and/or cause, at least in part, the turbulence and/or chaotic airflow generated by the fairing. There may be two or more upstream airflow detachment regions which are interleaved between, and upstream of, respective downstream airflow detachment regions. There may be a series (e.g. at least five of each) of alternating upstream airflow detachment regions and downstream airflow detachment regions, for example where at the local level every pair of adjacent upstream airflow detachment regions is separated by a downstream airflow detachment region and every pair of downstream airflow detachment regions is separated by an upstream airflow detachment region). A sawtooth profile, for example a triangular sawtooth profile at the trailing edge of the fairing, may provide such a series of alternating upstream airflow detachment regions and downstream airflow detachment regions. The teeth of the sawtooth profile may be streamlined with the local airflows, which may be good insofar as drag caused by the fairing is concerned. One or more teeth of the sawtooth profile may project into the freestream air, which may increase drag but also increase the turbulent airflow caused by the teeth. The sawtooth profile may have more than five teeth. The sawtooth profile may have ten or more teeth.

The fairing is preferably static. The fairing being static (e.g. not separately stowable or able to be moved to a different configuration or position) avoids the need for moving parts in use, and thus simplifies design and construction. The shape of the fairing may comprise a ramp which leads (in the downstream direction) to a trailing edge. The ramp may be convex in shape. The ramp may have a width that increases in the downstream direction. The upmost part of the trailing edge (i.e. the part furthest from the aircraft structure—which may for example be the mid-part of the trailing edge in the widthwise direction) of the fairing may be upstream of one or more parts of the trailing edge that are closer to the aircraft structure than to the upmost part of the trailing edge. It may be that no portion of the upmost part of the trailing edge is downstream of such one or more parts of the trailing edge that are closer to the aircraft structure.

The aircraft structure may be part of an aircraft, for example before final assembly. The disclosure herein also provides an aircraft comprising an aircraft structure according to the first aspect of the disclosure herein. Such an aircraft may be configured for flight in which thrust is generated at least in part by one or more electrically powered engines. The aircraft may be a hybrid aircraft, in which one or more combustion engines are provided to generate thrust and/or one or more combustion engines are provided to (re-)charge an electric power source that powers an electric engine. The one or more combustion engines provided to (re-) charge an electric power source may also be configured to directly power the electric engine.

An aircraft according to an embodiment of the disclosure herein may comprise one or more rechargeable energy cells for producing electric energy for powering one or more electrically powered thrust-generating engines of the aircraft. The aircraft may comprise one or more combustion engines for recharging the one or more rechargeable energy cells. The exhaust outlet may for example be configured to allow hot gases to flow from an exhaust of the combustion engine to the exterior of the aircraft. The combustion engine that generates the hot gases that flow out of the exhaust outlet may thus be a non-thrust generating engine. The one or more combustion engines for recharging the energy cells may together be capable of generating at least 0.5 MW and possible 1 MW or more of power output, available for recharging the energy cells. For example, the one or more combustion engines for recharging the one or more rechargeable energy cells may have a power rating of 500 kVA or more.

It may be that the combustion engine for recharging the energy cells may additionally perform the function of an auxiliary power unit (APU) of the aircraft. Increasing the capacity of the combustion engine to perform the dual functions of recharging the energy cells and the function of the auxiliary power unit (APU) may enable mass of the aircraft to be lower than would otherwise be the case. There may however be advantages in certain embodiments of providing a further combustion engine (for example a dedicated unit) to perform the function of the APU.

The aircraft may be an all-electric aircraft, in that all of the thrust generating engines are electrically powered. There may be benefit in the aircraft comprising one or more thrust generating engines that are electrically powered and one or more thrust generating combustion engines. The thrust generating engines of the aircraft may be wing-mounted, and preferably underwing, engines.

The one or more combustion engines for recharging the one or more rechargeable energy cells may have a power rating that is sufficiently high that the size and mass of the combustion engine(s) is greater than an APU of the size typical for the aircraft frame. The one or more combustion engines may form part of a power generator system having a volume of greater than 1 m³ for example, and possibly 2.5 m³ or greater. The power generator system may weigh at least 500 Kg, possibly more than 1 tonne, and may in some embodiments be 2 tonnes or heavier. The power generator system and/or the combustion engines for recharging the one or more rechargeable energy cells may be located in the fuselage of the aircraft, for example being spaced apart from the tail of the aircraft. For example, the power generator system and/or the combustion engines may be more than 1 meter and possibly more than 2 meters from a junction between the empennage and the fuselage. The center of mass of the power generator system and/or the combustion engines may be more than 3 meters, optionally more than 5 meters away from the junction between the empennage and the fuselage. There may be a rear bulkhead that is located at the junction between the empennage and the fuselage. In other embodiments at least part of the power generator system and/or the combustion engines for recharging the one or more rechargeable energy cells may be located in the tail of the aircraft. In such cases, if the exhaust outlet is positioned on a part of the tail, the outlet will typically be positioned at least one meter forward of the extreme end of that part of the tail.

The aircraft is preferably a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and more preferably more than 50 passengers.

According to a second aspect of the disclosure herein there is also provided a method of exhausting hot gas from within an aircraft. The method may use the exhaust outlet and fairing described with reference to the first aspect of the disclosure herein. The method comprises a step of exhausting hot gas from within the aircraft via an outlet. The direction of flow of gas immediately before exiting the aircraft via the outlet may be perpendicular to the longitudinal axis of the aircraft within +/−30 degrees. Additionally or alternatively, the direction of flow of gas immediately before exiting the aircraft via the outlet may be perpendicular to the plane of the outlet within +/−30 degrees. The outlet is accommodated within an exterior surface of the aircraft. The exterior surface of the aircraft may for example extend for at least 1 meter downstream of the outlet, possible more than 2 or optionally 3 meters or more in certain embodiments. A fairing, at least part of which is located upstream of the outlet, mixes the freestream air and the hot gases more rapidly than would be the case without the fairing, for example by creating turbulent airflow over and/or downstream of the outlet.

The exhausting of hot gas from within the aircraft via the outlet may result in more than 1 kg of gas being exhausted per second, possibly 2 kg or more per second, and in some embodiments greater than 5 kg per second. The temperature of the hot gas as measured at the outlet may be greater than 100 degrees Celsius.

According to a third aspect of the disclosure herein there is also provided an aircraft configured for flight in which thrust is generated at least in part by one or more electrically powered engines, wherein the aircraft comprises one or more rechargeable energy cells for producing electric energy for powering the one or more electrically powered engines, a combustion engine (for example inside the aircraft) for recharging the one or more rechargeable energy cells. The aircraft includes an exterior surface in which an outlet is located, and an exhaust duct leading via an interior space within the aircraft from the exhaust of the combustion engine and terminating at the outlet. The direction of the exhaust duct, in the region directly adjacent to the exhaust outlet, is transverse (e.g. perpendicular +/−30 degrees) to a longitudinal axis of the aircraft. The aircraft includes a fairing located immediately upstream of the outlet having a trailing edge with a sawtooth profile. The sawtooth profile of the fairing may assist in mixing the hot gases with the freestream air when the hot gases are exhausted when the aircraft is airborne, and thus reduce the risk of undesirable heating of the aircraft surfaces immediately surrounding and/or downstream of the outlet. The one or more energy cells may collectively be capable of storing at least 5 MWh of charge and preferably 8 MWh or more, for example at least 10 MWh.

It will of course be appreciated that features described in relation to one aspect of the disclosure herein may be incorporated into other aspects of the disclosure herein. For example, the method of the disclosure herein may incorporate any of the features described with reference to the apparatus of the disclosure herein and vice versa. Also, the outlet and fairing of the first aspect of the disclosure herein may be incorporated into the aircraft of the third aspect of the disclosure herein.

### BRIEF DESCRIPTION OF THE DRAWINGS

Embodiments of the disclosure herein will now be described by way of example only with reference to the accompanying schematic drawings of which:

FIG. 1 is a side view of an aircraft according to a first embodiment of the disclosure herein;

FIG. 2 is a plan view of the aircraft of FIG. 1;

FIG. 3 is a further simplified side view of the aircraft of FIG. 1 showing the location of an exhaust outlet and associated fairing;

FIG. 4 is a further simplified plan view of the aircraft of FIG. 1 showing the location of the exhaust outlet and associated fairing also shown in FIG. 3;

FIG. 5 is a perspective view of part of the aircraft of FIG. 1 with an enlarged view of the exhaust outlet and associated fairing;

FIG. 6 is a schematic view from the side of the exhaust outlet and associated fairing showing schematically airflows in use; and

FIG. 7 is a flowchart of a method of exhausting hot gas from within an aircraft using the apparatus of the first embodiment.

### DETAILED DESCRIPTION

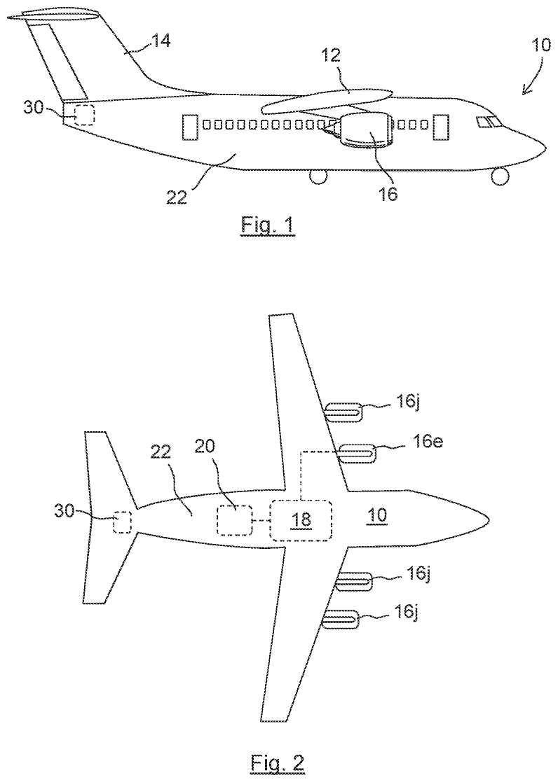

FIG. 1 shows a side view of an aircraft 10 in accordance with an embodiment of the disclosure herein. FIG. 2 is a plan view showing the outline of the aircraft 10 of FIG. 1. The aircraft 10 has two wings 12 and a tail plane/empennage 14.

The aircraft 10 has four wing-mounted engines 16 in the form of three conventional jet engines 16j and a single electrically powered engine 16e. The aircraft 10 is in the form of a demonstrator aircraft designed to test the feasibility of an electric aircraft, namely an aircraft for which the thrust is provided at least in part by one or more electric motors. In this embodiment, only a single engine 16e is electric, the other three being jet engines 16j. It will be appreciated however that the concept embodied by the aircraft of FIGS. 1 and 2 could be extended to an aircraft with two, three or all four engines being electric engines. The aircraft 10 also includes an auxiliary power unit (APU) 30 which is located at the very rear of the aircraft.

The electric motor 16e is powered by a high-power battery pack 18, which is mounted within the fuselage 22 of the aircraft. The battery pack 18 is connected to an on-board power generator system 20, for the purpose of extending the life of the battery during a single operation of the aircraft (i.e. from take-off to landing inclusive, and associated taxiing manoeuvres) and for directly powering the electric motor 16e. The battery pack is configured to be capable of storing at least 10 MW-hours of electrical charge. The power generator system 20 comprises a gas turbine combustion engine which is able to deliver 2.5 MW of power which is converted to electricity by a generator. The power generator system 20 weighs about 2,500 Kg and is about 3.5 meter long (in the direction of the central longitudinal axis 24 of the aircraft) and about 1 meter in height and width.

The power generator system 20 is also mounted within the fuselage 22 of the aircraft and is fed with jet fuel stored in one of more fuel tanks and air fed via an intake system (not shown in the drawings). The size and weight of the power generator system 20 is such that it needs to be mounted within the fuselage and in a position set apart from the bulkhead (not shown separately in the Figures) that separates the empennage 14 and the fuselage 22. It is therefore the case that the power generator system 20 is located in the fuselage and spaced apart, in the longitudinal direction, from the extreme aft end of the tail of the aircraft. It is also the case that the center of mass of the power generator system 20 is spaced apart, in the longitudinal direction, from the fore end of the empennage 14. As such, consideration needs to be given to how best to exhaust the hot exhaust gases that are exhausted from the combustion engine of the power generator 20 in use, it not being feasible to vent exhaust gases from the extreme rear of the aircraft.

In the configuration of the present embodiment, the free space within the fuselage means that exhaust gases need to be exhausted from the fuselage in a direction that is close to perpendicular both to the external surface of the aircraft surrounding the exhaust outlet and to the longitudinal axis of the aircraft. It might be thought that exhausting hot gases in this direction would assist with reducing the amount of undesirable contact of undiluted hot gases with the aircraft structure immediately downstream of the exhaust outlet. However, the local free-stream flow around the aircraft when airborne tends to entrain any such hot gases introduced to the free-stream flow close to the aircraft body.

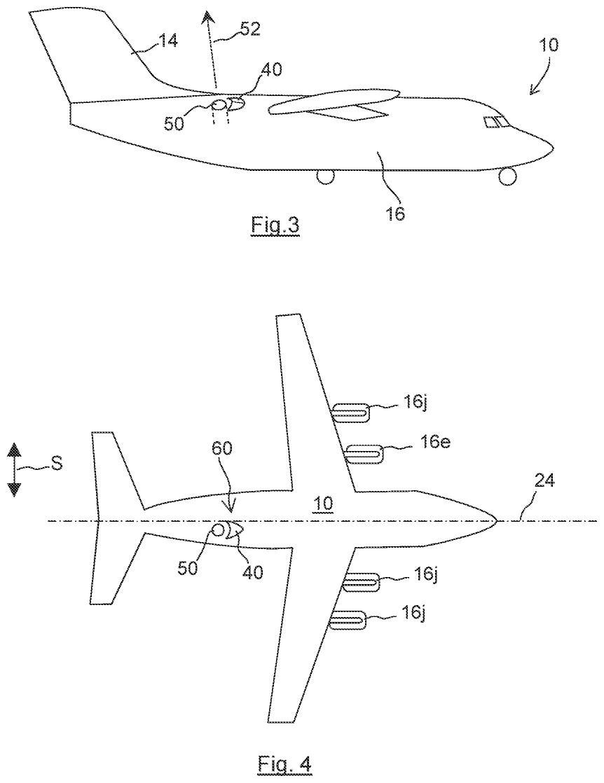

According to the present embodiment, and as shown in FIGS. 3 to 6, a fairing 40 is provided immediately upstream of the exhaust outlet 50 to promote better mixing of the hot exhaust gases and the free-stream air so as to reduce undesirable heating of the external aircraft structure immediately downstream of the exhaust outlet by the exhaust gases. The fairing 40 is static, has a rigid and fixed shape and is mounted at a fixed location on the aircraft 10. The fairing has a length aligned with the longitudinal axis 24 of the aircraft and a width aligned with a widthwise direction W. The shape of the fairing 40 includes a shallow convexly shaped ramp profile 42 that ramps up and flares out (increases in size in the widthwise direction W) in a downstream direction DD, before terminating in a saw-tooth profile 44. The saw tooth profile 44 has a slanted concave arrangement of thirteen teeth that are positioned next to each other in the widthwise direction. The arrangement of teeth is concave in that the first and last end teeth 44e in the arrangement are closest to the aircraft external surface 60 and the middle teeth 44m are furthest away from the external surface 60 (and are therefore the upmost teeth). The arrangement of teeth is slanted in that the first and last teeth 44e in the arrangement are further downstream than the middle teeth 44m.

The shape of the fairing 40 is designed so as to create a turbulent and chaotic airflow over and downstream of the outlet, which increases the mixing of, and dispersion of, hot exhaust gases within the free-stream air. With reference to FIG. 6, each of the teeth of the saw tooth profile defined an airflow detachment region 48 (only some of which being labeled) that are arranged in a series in the widthwise direction. The airflow upstream of the fairing (region R1) is relatively smooth (laminar flow). The airflow over the fairing (region R2) detaches from the fairing and causes a disturbed airflow (region R3) at and downstream of the airflow detachment regions. The pointed free ends the teeth on the fairing 40 may be considered as downstream detachment regions and the junction between adjacent teeth as upstream airflow detachment regions, such that there is an alternating series of downstream airflow detachment regions and upstream airflow detachment regions on the downstream end of the fairing. There may thus be multiple single upstream airflow detachment regions each of which are interleaved between, and upstream of, a pair of respective downstream airflow detachment regions. Such an arrangement promotes turbulence and chaotic airflows over and downstream of the outlet (i.e. within region R3 in FIG. 6). Thus, the hot air flow (dashed arrows 54) emerging from the exhaust outlet 50 mixes with the free-stream air better.

The shape of the fairing is also designed to have minimal effects on drag, although it is acknowledged that its introduction on the fuselage outer surface will increase drag, albeit by a relatively small percentage.

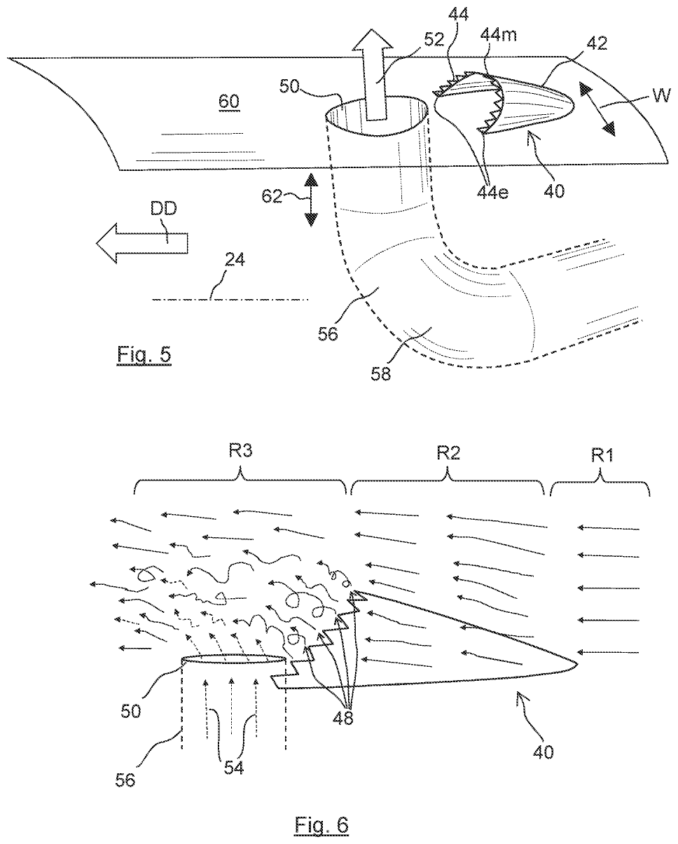

The shape of the pipe 56 that supplies hot exhaust gases from the power generator system 20 is shown in FIG. 5. It will be seen that the direction (represented by arrow 52) of the axis of the pipe 56 at the region of the outlet 50 is close to being perpendicular to both the local plane of the external surface 60 of the aircraft and perpendicular to the longitudinal axis. In this embodiment a single direction, shown as double-headed arrow 62, is both perpendicular to the plane of the external surface 60 and perpendicular to the longitudinal axis. It will be seen that arrow 52 is in the same general direction as double-headed arrow 62, although not exactly parallel in this case. The pipe 56 has an elbow 58 which causes a change in direction of the exhaust gases from being closer to the longitudinal axis 24 of the aircraft at a location upstream (in the direction of the exhaust gases) to a direction being at a greater angle from the longitudinal axis 24 at a downstream location (i.e. close to the outlet). It will be seen that the direction 52 of the exhaust duct 56 is transverse (and close to exactly perpendicular) to the longitudinal direction 24 at the point at which the pipe 56 terminates at the outlet 50. The pipe 56 has a diameter of about 50 cm so that the area of the outlet is about 0.2 m² (and therefore in the range of between 0.05 m² and 1.0 m²).

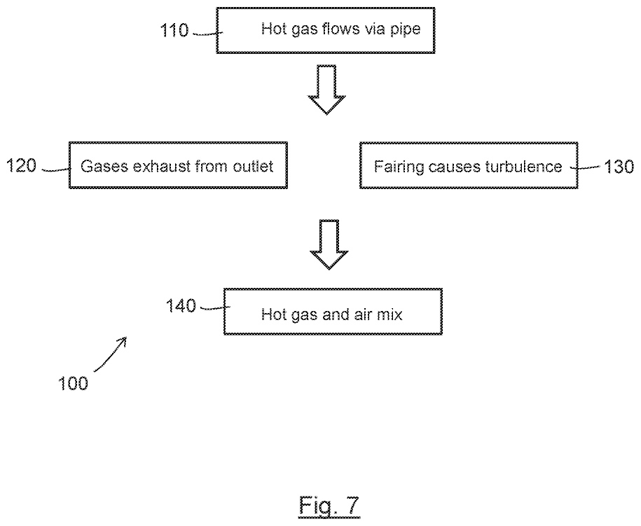

The method of operation of aircraft having an exhaust outlet 50 and fairing 40 as shown in FIGS. 1 to 6 will now be described with reference to the flowchart 100 shown in FIG. 7. Hot exhaust gases flow from a source (in this case a combustion engine of an on-board power generator system) via an exhaust pipe (step 110) within an airborne aircraft. Exhaust gas flows from the pipe, out of the aircraft, via the exhaust outlet (step 120). The temperature of the gas is greater than 100 degrees Celsius and about 30 Kg of hot gas is exhausted per second. The outlet is accommodated within an exterior surface of the aircraft which extends for at least 2 meters downstream of the outlet. If the downstream extent of the exterior surface of the aircraft were less than 1 meter then it might make treating the downstream exterior surface of the aircraft with heat protection a more attractive option. The direction of flow of gas immediately before exiting the aircraft via the outlet is perpendicular to the longitudinal axis of the aircraft (within +/−30 degrees). The direction of flow of gas immediately before exiting the aircraft via the outlet is also perpendicular to the plane of the outlet (within +/−30 degrees). The plane of the outlet should in most cases be clear, but if there is doubt over the matter (e.g. the outline of the outlet does not lie on a single plane), the plane can be defined as one which (a) bisects the outline of the outlet so that exactly half the outline is on one side of the plane and (b) has its normal axis parallel to the axis of the exhaust pipe where it crosses the plane. The fairing, being located upstream of the outlet, creates turbulent airflow (step 130), which passes over and downstream of the outlet so as to mix the freestream air and the hot gas more rapidly than would be the case without the fairing (step 140).

While the disclosure herein has been described and illustrated with reference to particular embodiments, it will be appreciated by those of ordinary skill in the art that the disclosure herein lends itself to many different variations not specifically illustrated herein. By way of example only, certain possible variations will now be described.

The aircraft may be a commercial aircraft, not merely a demonstrator aircraft.

The combustion engine of the on-board power generator system may additionally perform the function of an auxiliary power unit (APU) of the aircraft.

The power generator system may be provided more as a back-up to the battery pack, and not necessarily operational during a flight. The extent to which of the battery pack and the on-board power generator system is seen as the primary power source for driving the electric motor and which is seen more of a secondary power source (or back-up for example) may be altered as so desired.

Although the embodiments are described in the context of a fixed-wing aircraft application, there may be potential benefits in relation to various other applications, including but not limited to applications on vehicles such as helicopters, drones, and spacecraft. The source of hot gases need not be the exhaust gases from a combustion engine. The source of hot gases could for example be generated by a heat exchange system within an aircraft.

The size and power-rating of the on-board power generator system may be scaled upwards or downwards according to the weight and size of the aircraft with which it is to be used.

Where in the foregoing description, integers or elements are mentioned which have known, obvious or foreseeable equivalents, then such equivalents are herein incorporated as if individually set forth. Reference should be made to the claims for determining the true scope of the disclosure herein, which should be construed so as to encompass any such equivalents. It will also be appreciated by the reader that integers or features of the disclosure herein that are described as preferable, advantageous, convenient or the like are optional and do not limit the scope. Moreover, it is to be understood that such optional integers or features, while of possible benefit in some embodiments of the disclosure herein, may not be desirable, and may therefore be absent, in other embodiments.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft structure comprising an outer surface that in use is on an exterior of an aircraft, the aircraft having a longitudinal axis, wherein:
the outer surface accommodates an exhaust outlet configured to allow hot gases to flow from within the aircraft to the exterior of the aircraft, a direction of flow of gases immediately before exiting via the exhaust outlet being transverse to the longitudinal axis of the aircraft;
the outer surface extends downstream of the exhaust outlet; and
the aircraft structure comprises a fairing located immediately upstream of the exhaust outlet having a shape that creates turbulence and/or chaotic airflow over and downstream of the exhaust outlet.

2. The aircraft structure according to claim 1, wherein the aircraft structure comprises an exhaust duct that terminates at the exhaust outlet and extends from inside the aircraft from a supply of hot gases.

3. The aircraft structure according to claim 2, wherein a direction of the exhaust duct is transverse to the longitudinal axis in a region directly adjacent to the exhaust outlet.

4. The aircraft structure according to claim 3, wherein the direction of the exhaust duct in the region directly adjacent to the exhaust outlet is different from a direction of the exhaust duct in a region upstream of the outlet.

5. The aircraft structure according to claim 1, wherein the fairing has a length and a width, the width being along a widthwise direction which is perpendicular to the longitudinal axis of the aircraft, and the fairing has a shape which creates a series of airflow detachment regions distributed across the widthwise direction such that airflow over the fairing detaches from the fairing and causes a disturbed airflow at the airflow detachment regions, there being two or more upstream airflow detachment regions which are interleaved between, and upstream of, respective downstream airflow detachment regions.

6. The aircraft structure according to claim 1, wherein the fairing has a trailing edge which has a sawtooth profile.

7. An aircraft comprising the aircraft structure according to claim 1.

8. The aircraft according to claim 7, wherein:
the aircraft is configured for flight in which thrust is generated at least in part by one or more electrically powered engines; and
the aircraft comprises:
one or more rechargeable energy cells for producing electric energy for powering the one or more electrically powered engines; and
one or more combustion engines for recharging the one or more rechargeable energy cells;
the exhaust outlet being configured to allow hot gases to flow from an exhaust of the combustion engine to the exterior of the aircraft.

9. The aircraft according to claim 8, wherein at least one of the one or more combustion engines additionally performs a function of an auxiliary power unit of the aircraft.

10. The aircraft according to claim 8, wherein a further combustion engine is supplied to perform the function of an auxiliary power unit of the aircraft.

11. The aircraft according to claim 7, wherein the aircraft includes one or more combustion engines for directly generating thrust.

12. The aircraft according to claim 8, wherein the one or more combustion engines for recharging the one or more rechargeable energy cells have a power rating of 500 kVA or more.

13. The aircraft according to claim 8, wherein the one or more combustion engines for recharging the one or more rechargeable energy cells are located in a fuselage of the aircraft, and spaced apart from a tail of the aircraft.

14. A method of exhausting hot gas from within an aircraft comprising:
exhausting hot gas from within the aircraft via an outlet, a direction of flow of gas immediately before exiting the aircraft via the outlet being perpendicular to the longitudinal axis of the aircraft within +/−30 degrees, the outlet being accommodated within an exterior surface of the aircraft which extends for at least 1 meter downstream of the outlet;
a fairing, at least part of which is located upstream of the outlet, creating turbulent airflow over and/or downstream of the outlet to mix the freestream air and the hot gas more rapidly than without the fairing.

15. An aircraft configured for flight in which thrust is generated at least in part by one or more electrically powered engines, wherein the aircraft comprises:
one or more rechargeable energy cells for producing electric energy for powering the one or more electrically powered engines;
a combustion engine for recharging the one or more rechargeable energy cells;
an exterior surface in which an outlet is located;
an exhaust duct leading via an interior space within the aircraft from the exhaust of the combustion engine and terminating at the outlet, a direction of the exhaust duct, in a region directly adjacent to the exhaust outlet, being transverse to a longitudinal axis of the aircraft; and
and a fairing located immediately upstream of the outlet having a trailing edge with a sawtooth profile.
